(19) United States
(12) Patent Application Publication
(10) Pub. No.: US 2002/0063681 A1
(43) Pub. Date: May 30, 2002

(54) Networked system for producing multimedia files and the method thereof

(76) Inventors: Hsin Ting Lan, Taipei (TW); Wesley Shih, Taipei (TW); Ho Fa Chiang, Taipei Hsien (TW); Vincent Lu, Taipei (TW); Milton Chen, Taichung Hsien (TW)

Correspondence Address: BIRCH STEWART KOLASCH & BIRCH, PO BOX 747, FALLS CHURCH, VA, 22040-0747, US

(21) Appl. No.: 09/981,918

(22) Filed: Oct. 19, 2001

(30) Foreign Application Priority Data
Jun. 4, 2000 (TW) 90113481

(51) Int. Cl. G09G 5/00

(52) U.S. Cl. 345/156

(57) ABSTRACT

The present invention provides a method for producing a multimedia file via a network comprising the steps of: storing a plurality of multimedia objects at a plurality of corresponding layers, generating an interface displaying the layers, through which the multimedia objects are selected according to the layers at a first client, and combining the selected multimedia objects to generate a first multimedia file at a server.

### BACKGROUND OF THE INVENTION

1. Field of the Invention

The present invention relates to a network system for producing multimedia files and the method thereof, particularly to a network system for producing multimedia files and a method thereof which provides a user interface having an object-oriented and layered structure.

2. Description of the Prior Art

Posters are a popular tool for advertisement. Conventionally, posters are produced by a print shop, which is not comparable with the modern and fast production of a PC printing system. The quality, resolution and paper variety of posters produced by a PC system are higher than those produced by the print shop. Furthermore, as the Internet becomes more and more popular, posters can now be produced via a website. Users can chose between sample posters or design one themselves on the website and a digital file is produced and sent to the printing system.

However, there is no object-oriented editing tool provided for users on the websites described above. The drawbacks are:

1. Only a non-object-oriented file, such as BMP or JPEG, can be used if the user does not install an object-oriented editing software application, such as Corel Draw or AutoCAD on their computer. It is well known that, for a certain size and resolution of an image, the size of the transferred non-object-oriented file representing the image is much larger than that of an object-oriented file, such as CDR for Corel Draw or DWG for AutoCAD. This is a disadvantage for data transmission on the Internet.

2. An object-oriented file can be used only if the user has an object-oriented editing software application in his computer. Generally, object-oriented editing software applications are expensive and not popular with users. This is a disadvantage for promoting the popularization of the website.

Furthermore, there is no layering capability in the user interface of the current websites for poster production. Everything on the poster must be created by the user, and no reference structure or template is provided when designing the poster. This is not easy for non-professional designers.

### SUMMARY OF THE INVENTION

Therefore, the object of the present invention is to provide a network system for producing a multimedia file and the method thereof, which provides a database storing description data of image and text objects at various layers for users. A user interface at the client having layering capability is also provided. Users choose and modify the image or text objects in the database for each layer. The server, having an object-oriented application combines the selected objects for each layer and produces a digital multimedia file. The modification of the objects and production of the file are executed at the server so that the object-oriented editing tool is not necessary at the client.

The present invention provides a method for producing a multimedia file via a network comprising the steps of: storing a plurality of multimedia objects at a plurality of corresponding layers, generating an interface displaying the layers, through which the multimedia objects are selected according to the layers at a first client, and combining the selected multimedia objects to generate a first multimedia file at a server.

The present invention further provides a network system for producing a multimedia file comprising a storage device storing a plurality of multimedia objects at a plurality of corresponding layers, an interface device generating an interface displaying the layers, through which the multimedia objects are selected according to the layers at a first client, and a processing device combining the selected multimedia objects to generate a first multimedia file at a server.

### BRIEF DESCRIPTION OF THE DRAWINGS

The following detailed description, given by way of example and not intended to limit the invention solely to the embodiments described herein, will best be understood in conjunction with the accompanying drawings, in which:

FIG. 1 is a diagram showing a network system according to one embodiment of the present invention.

FIG. 2 is a diagram showing a CDR file used in one embodiment of the invention.

FIGS. 3 and 4A˜4E are diagrams showing the user interface of one embodiment of the invention.

FIG. 5 is a flow chart of the method for producing a multimedia file according to one embodiment of the invention.

### DETAILED DESCRIPTION OF THE INVENTION

The present invention provides a web-based platform to which media designers and composers upload their object-oriented files (CDR, DWG or MIDI files) created by object-oriented editing tools (Corel Draw, AutoCAD or applications for editing MIDI files). Image, text or sound objects are extracted from the uploaded files by a sever. These objects and their descriptive data such as contents of the text objects, sizes and positions of the image objects, or keys and pitches of the sound objects, are then stored in a database at various layers, such as title layer, picture layer, layer for oral voice, first and second instrument etc. The server also send to the client a user interface guiding the user to choose among the stored objects for each layer and modify the descriptive data of the selected objects. As soon as a combination of the objects for each layer is determined, the server produces a corresponding object-oriented file which is then transferred to an output system to generate a poster or music CD, or produces a corresponding non-object-oriented file which is then transferred to the client for previewing. Thus, the designers, users and output system are connected via the platform which is suitable for development of E-commerce-based multimedia production.

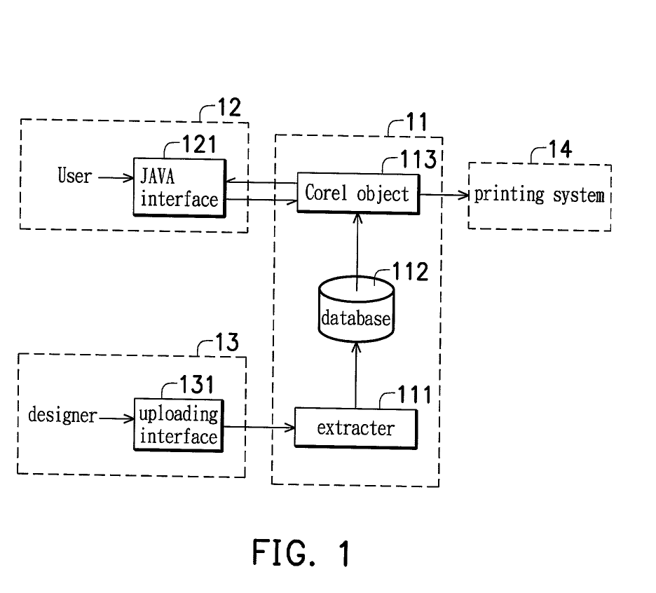

FIG. 1 is a diagram showing a network system according to one embodiment of the present invention.

The network system comprises a server 11, a first client 12 for users, a second client 13 for designers and a poster printing system 14.

The second client 13 for the designers has an interface for uploading, such as an FTP uploading application. CDR files Poster1.cdr and Poster2.cdr are transferred to the server 11 via the uploading interface and input to the extractor 111.

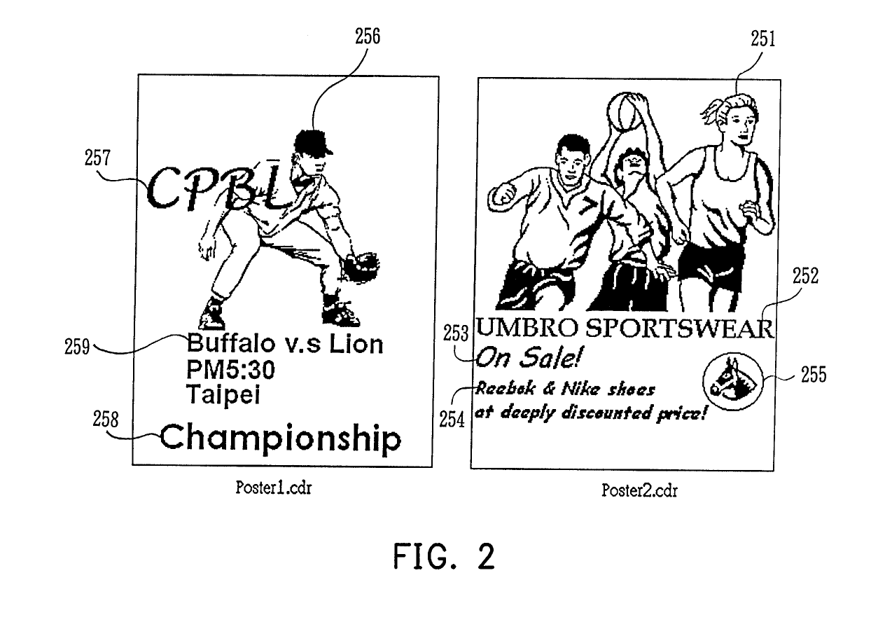

FIG. 2 is a diagram showing the CDR files. Poster1.cdr comprises an image object 256 and three text objects 257, 258 and 259, and Poster2.cdr comprises image objects 251 and 255, and three text object 252, 253 and 254.

The extractor 111 of the server 11 receives the files Poster1 and Poster2 and uses a Visual Basic program to extract the image and text objects 251˜259 which are then stored at different layers. The image objects 251 and 256 are stored at a picture layer, the image object 255 is stored at an logo layer, the text objects 252 and 257 are stored in a title layer, the text objects 253 and 258 are stored in a subtitle layer, and the text objects 254 and 259 are stored at a text layer. Descriptive data of the objects 251-259 are stored in a data base 112. The descriptive data of the text object 252˜254 and 27˜259 is the words of the text and that of the image objects is the size and position of the image. For example, the descriptive data of the text object 253 is “On Sale!” and that of the image object 256 is Size(200, 236) and Position(1.00029, 1.13409). The server 11 has a Corel object composed of a series of Common Object Models.

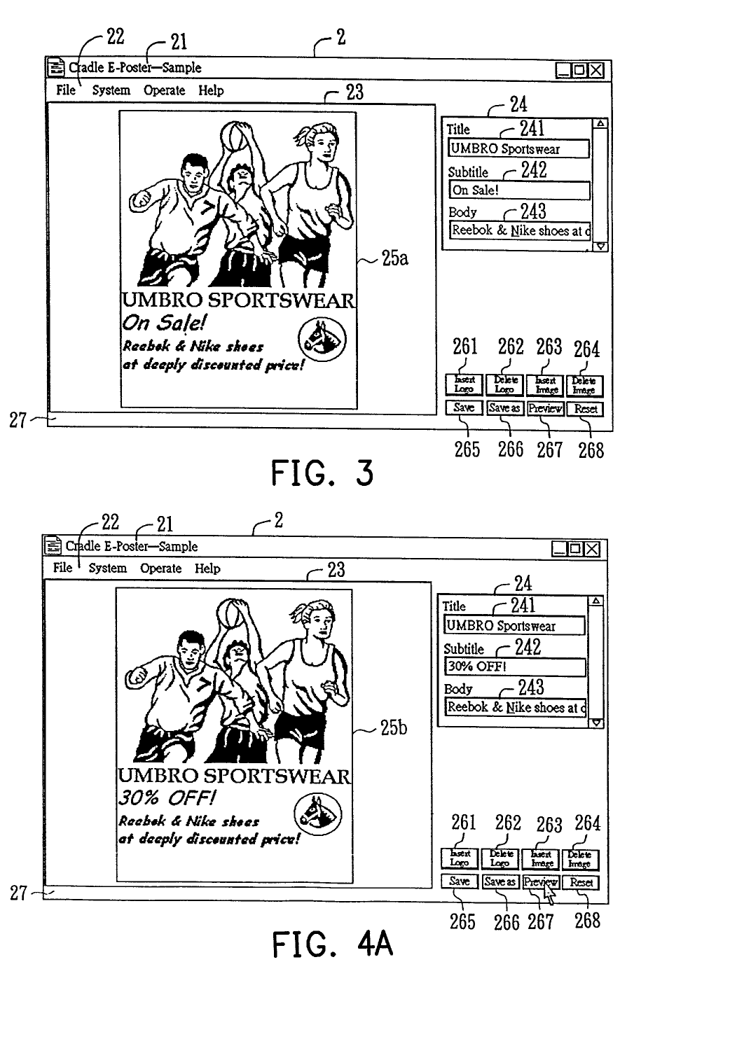

When the first client 12 reads out the website homepage from the server 11, JPEG thumbnails of the files Poster1 and Poster2 are displayed on the homepage for the user to choose from. For example, when the user selects Poster2, the server 11 transfers a JAVA applet 121 to the first client 12 to generate a user interface shown in FIG. 3.

The user interface comprises a main window 2 having a title 21, a tool bar 22, a working area 23, a menu bar 24, buttons 261˜268 and a graphical information bar 27. Since the Poster2 is selected, the JAVA applet 121 sends a request to the server 11 so that the Corel object in the server 11 reads out the descriptive data of the objects 251˜255 stored in the database 112 and generates a JPEG file 25a which is sent back to the first client 12 and displayed in the working area 23. The words of the text objects 252, 253 and 254 are displayed in boxes 241, 242 and 243 for the title, subtitle and text of the poster respectively.

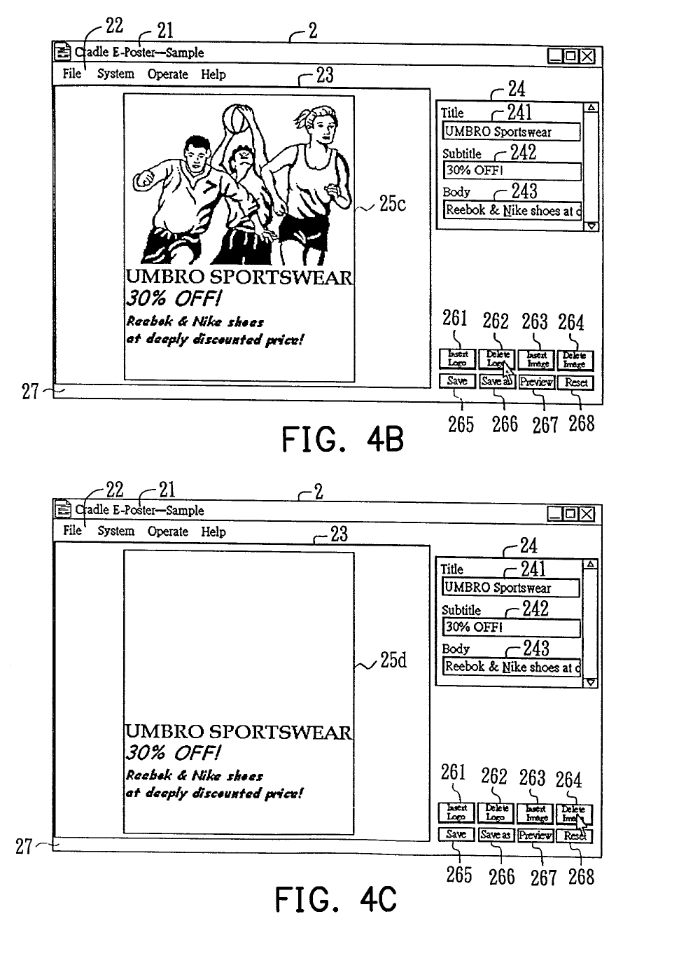

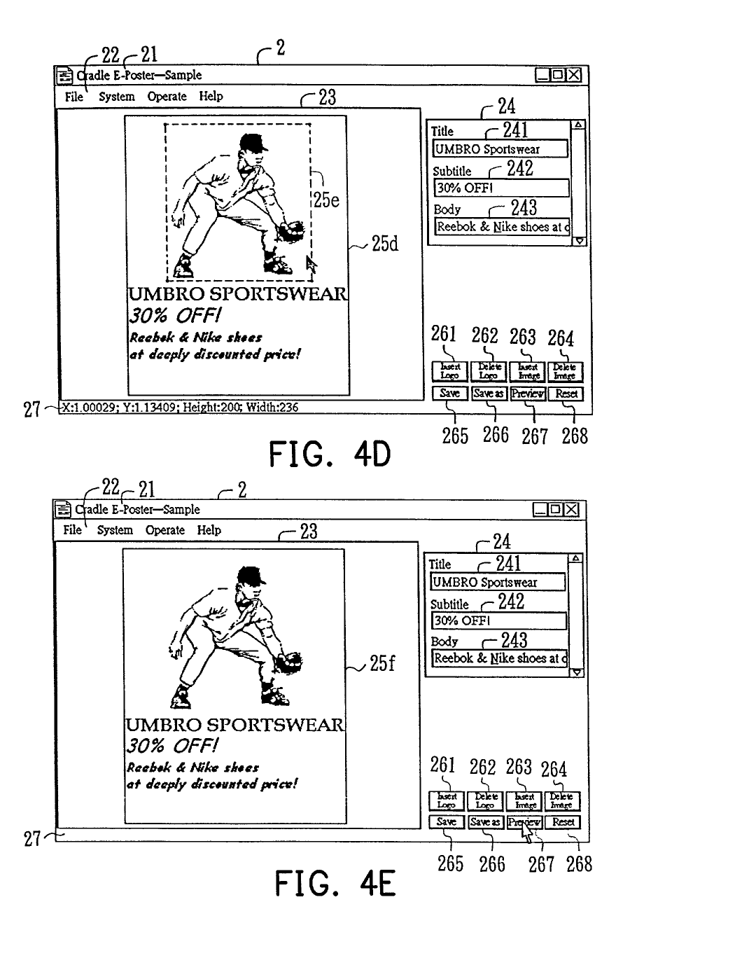

The user may wish to modify the subtitle. As shown in FIG. 4A, the words in the subtitle box 242 are changed from “On Sale!” to “30% OFF!” and the Preview button 267 is pressed so that the JAVA applet sends the new subtitle content to the Corel object in the server 11 to generate a new JPEG file 25b replacing the old JPEG file 25a. The JPEG file 25b is sent back to the first client 12 and displayed in the working area 23.

Next, the user may wish to delete the logo. As shown in FIG. 4B, the Delete Logo button 262 is pressed so that the JAVA applet sends an elimination of the image object 255 to the Corel object in the server 11 to generate a new JPEG file 25c replacing the old JPEG file 25b. The JPEG file 25c is sent back to the first client 12 and displayed in the working area 23.

Further, the user may wish to change the picture. First, as shown in FIG. 4C, the Delete Image button 264 is pressed so that the JAVA applet sends an elimination of the image object 251 to the Corel object in the server 11 to generate a new JPEG file 25d replacing the old JPEG file 25c. The JPEG file 25d is sent back to the first client 12 and displayed in the working area 23. Second, as shown in FIG. 4D, the Insert Image button 263 is pressed so that the JAVA applet 121 generates a select window (not shown) displaying the thumbnails of all the image objects stored at picture layer for the user to choose from. The image object 256 is selected so that the JAVA applet sends a request to the Corel object in the server 11 to generate a JPEG file 25e representing the image object 256. The JPEG file 25e is sent back to the first client 12 and displayed in the working area 23 in its original size and position. The JAVA applet 121 also allows the user to modify the size and position of the image object 256. The user drags the JPEG file 25e to move, enlarge or shrink the image and the modified size (height and position of the image appears in the graphic information bar 27. Third, as shown in FIG. 4E, the Preview button is pressed so that the JAVA applet 121 sends a request to the Corel object in the server 11 to generate a JPEG file 25f replacing the file 25d. The JPEG file 25f is sent back to the first client 12 and displayed in the working area 23.

Finally, editing is complete and the Save button 265 is pressed. The final result is sent to the server 11 by the JAVA applet 121 and stored in the database 112. The Corel object in the sever 11 reads out the final result from the database 112 and generates a corresponding CDR file which is sent to the printing system 14 and printed out.

Users can easily create their own poster via the network system described herein since a layered structure composed of the title, subtitle, text, picture and logo layers is available in the user interface, and the objects provided by another professional designer for each layer are already pre-stored in the server 11. Users need not create everything on the poster unaided. This is suitable for users not skilled in poster design.

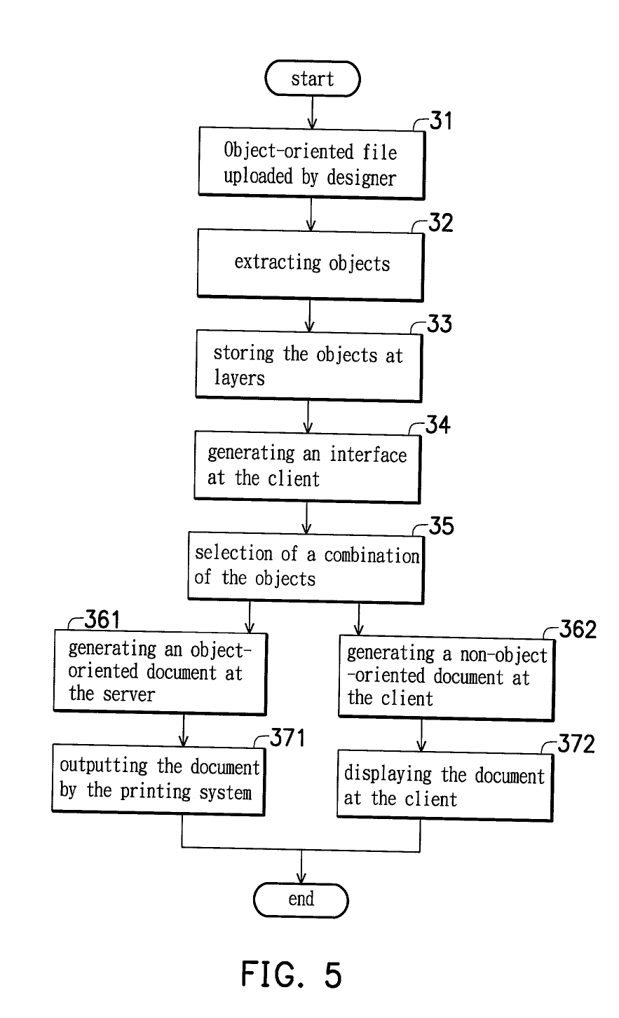

FIG. 5 is a flow chart of the method for producing a multimedia file according to one embodiment of the invention.

In step 31, a designer uploads an object-oriented file such as CDR for a poster to a server via an FTP uploading application. There are image and text objects in the file.

In step 32, the uploaded file is applied to a Visual Basic program in the server. The uploaded file is then extracted, and the image and text objects are extracted from the uploaded file. Their descriptive data is also generated.

In step 33, the objects extracted from the uploaded file are stored at various layers such as title, subtitle, logo and picture layer.

In step 34,the server transfer a JAVA applet to the client to generate a user interface. The user interface displays the layers, whereby the user can select objects for each layer and modify the descriptive data of the selected objects.

In step 35, the user determines the combination of the selected or modified objects.

Then, according to the user's request, the server generates a non-object-oriented file such as JPEG in step 362 and transfers it to the client for preview in step 372, or generates an object-oriented file such as CDR in step 361 and transfers it to a printing system for printing in step 371.

In conclusion, the server of the network system according to the present invention provides pre-stored objects uploaded by creators, an object-oriented application for manipulation of the files and a user interface having a layering capability guiding the user to create their own multimedia file. Thus, no object-oriented software application is needed at the client and those not skilled in multimedia design can easily create their own files. The network system provides a web-based platform connecting the designer, user and manufacturer.

While the invention has been described by way of example and in terms of the preferred embodiment, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method for producing a multimedia file via a network comprising the steps of:
storing a plurality of multimedia objects at a plurality of corresponding layers;
generating an interface displaying the layers, through which the multimedia objects are selected according to the layers at a first client; and
combining the selected multimedia objects to generate a first multimedia file at a server.

2. The method as claimed in claim 1 wherein the multimedia objects are descriptive data.

3. The method as claimed in claim 2 wherein modification data is obtained through the interface and one of the selected multimedia objects is modified according to the modification data.

4. The method as claimed in claim 2 wherein the descriptive data comprises descriptions of sizes, positions, fonts and texts.

5. The method as claimed in claim 1 wherein the multimedia object comprises a text object and an image object.

6. The method as claimed in claim 1 wherein the layers comprises a title layer, a subtitle layer, a logo layer, a picture layer and a text layer.

7. The method as claimed in claim 1 wherein the interface provides a template and multimedia objects are selected using the template.

8. The method as claimed in claim 1 wherein the first multimedia file is generated by a Corel element.

9. The method as claimed in claim 1 further comprising the step of:
transmitting a Java script generating the interface from the server to the first client.

10. The method as claimed in claim 1 further comprising the steps of:
receiving a second multimedia file from a second client; and
obtaining the multimedia objects from the second multimedia file.

11. The method as claimed in claim 10 wherein the multimedia objects are obtained from the second multimedia file using a Visual Basic element.

12. The method as claimed in claim 10 wherein the second multimedia file is an object-oriented file.

13. The method as claimed in claim 12 wherein the second multimedia file is a Corel Draw file.

14. The method as claimed in claim 1 further comprising the step of:
displaying the first multimedia file at the first client.

15. The method as claimed in claim 1 wherein the first multimedia file is a non-object-oriented file.

16. The method as claimed in claim 15 wherein the first multimedia file is a JPEG file.

17. The method as claimed in claim 1 further comprising the step of:
outputting the first multimedia file at a third client.

18. The method as claimed in claim 17 wherein the first multimedia file is an object-oriented file.

19. The method as claimed in claim 18 wherein the first multimedia file is a Corel Draw file.

20. A network system for producing a multimedia file comprising:
a storage device storing a plurality of multimedia objects at a plurality of corresponding layers;
an interface device generating an interface displaying the layers, through which the multimedia objects are selected according to the layers at a first client; and
a processing device combining the selected multimedia objects to generate a first multimedia file at a server.
